(19) United States
(12) Patent Application Publication
(10) Pub. No.: US 2023/0358137 A1
(43) Pub. Date: Nov. 9, 2023

(54) TWO STROKE INTERNAL COMBUSTION ROTARY ENGINE WITH ZINDLER CURVE RING GEAR

(71) Applicant: Rajish K. R, Ernakulam (IN)

(72) Inventor: Rajish K. R, Ernakulam (IN)

(21) Appl. No.: 17/777,514

(22) PCT Filed: Nov. 17, 2020
(86) PCT No.: PCT/IN2020/050964

§ 371 Date: May 17, 2022

(30) Foreign Application Priority Data
Nov. 18, 2019 (IN) 201941046899

(51) Int. Cl. F01C 21/00; F02B 53/02; F01C 21/08

(52) U.S. Cl. CPC F01C 21/008; F01C 21/08; F02B 53/02; F02B 2053/005

(57) ABSTRACT

A two stroke internal combustion rotary engine (30) with Zindler curve eccentric ring gear (8) and method of working of a two stroke internal combustion rotary engine (30) with Zindler curve eccentric ring gear is disclosed. The engine (30) has an equilateral triangular rotor (7) with Zindler curve shaped eccentric ring gear (8) with teeth. Output shaft (12) is fixed about to the center of the engine (30) with a center spur gear and it also connected to same sized another one or more spur gear (10) on the side of the center spur gear (11). When engine (30) start working, the rotor (7) and eccentric ring gear (8) will rotate eccentrically along with the side spur gears (10) connected to it, by running over the teeth cuts. Engine cover (16, 17) has a hole (20, 21) to allow a coolant to enter the rotor (7) and excel the heat.

### CROSS REFERENCE TO RELATED APPLCIAION

This present application claims the benefit of Indian provisional Patent Application 201941046899 filled on Nov. 18, 2019, and titled “R, G, S. ROTARY ENGINE”, which application is incorporated herein by reference in its entity.

### TECHNICAL FIELD

The present disclosure relates generally to a rotary engine. Embodiments of the disclosure are related to a two stroke internal combustion rotary engine with Zindler curve eccentric ring gear. Embodiments of the disclosure are also related to method of working of a two stroke internal combustion rotary engine with Zindler curve eccentric ring gear.

### BACKGROUND

Rotary engine is a kind of internal combustion engine, which is mainly used in aviation engineering and automobiles. Earlier times which was also used as an alternative for the inline or straight engine. It has so many advantages over other reciprocating internal combustion engines such as fewer moving parts, better reliability, less manufacturing cost, and less vibration.

A rotary engine includes a frame and interior of which is cylindrical shaped to form a chamber and rotor, and periphery is arranged in such a way that the rotor rotates within the chamber. Inlet and outlet valve in it will provide necessary suction, compression, combustion, and exhaustion phases. Disadvantages of the rotary engine are excessive wear in the sealing between the periphery of the rotor and the wall of the frame and low thermal efficiency as compared to the reciprocator engine which will cause high fuel consumption.

Among all rotary engines developed all over in the world Wankel engine is the most popular and widely used for industrial applications. And its works on Otto cyclic thermodynamic process. This engine suffers from certain problems such as leakage at the side seals, excessive wear and high fuel consumption.

The U.S. Pat. No. US5251596 discloses a two stroke cyclic rotary internal engine combustion engine of the Wankel type. The engine provides a flow through intake and exhaust with intake ports on one side wall of an epitrochoidal housing and exhaust ports on the opposite side wall. Compressed air is ducted to an intake plenum which provides a source of intake air as well as bypass air which is routed around the engine for engine cooling. A particular intake and exhaust man folding and port positioning provides centrifugal pumping for charging and scavenging. Both rotating and stationary housing engines are disclosed and a rotating housing engine having fuel charge stratification and centrifugal filtering of inlet air is also provided.

Another rotary engine disclosed in U.S. Pat. No. US3918415 comprises an elliptical cylinder, four piston elements operatively associated with each other to form a rotor in the shape of a regular quadrangle having angles which form a rhombus with sides of substantially equal length, said elliptical cylinder being concentric with a rotating shaft disposed in the centre of said regular quadrangle, the sides of said piston elements and the sides of the elliptical cylinder defining a plurality of chambers there between which extend between the respective vertices of the angles forming the regular quadrangle, and rod means for securing the centre portion of the piston elements to the rotating shaft.

Another rotary engine disclosed in U.S. Pat. Application No. US2010012077 A1 comprises of body, said body includes two generally cylindrical cavities therein; a main rotor mounted rotatable in one of said cylindrical cavities placed in the engine body; a secondary rotor mounted rotatable in the other cylindrical cavity placed in the engine body; an intermediate rotor, said intermediate rotor having one end and the other end, wherein one end of said intermediate rotor is rotatable mounted in the main rotor and the other end of said intermediate rotor is rotatable mounted in the secondary rotor.

There are so many variants of rotary internal combustion engines have been developed, but most of them were a failure at the commercial stage due to their high vibration, lack of required stability, overheat and inadequate cooling mechanism and so on. Moreover, all previously developed rotary internal combustion engines were not compatible with diesel fuel due to the lack of high compression ratio in such engines.

A need, therefore, exists for an improved rotary internal combustion engines system that overcomes above problems.

### OBJECT OF THE INVENTION

The principal object of the invention is to develop a two stroke internal combustion engine.

Another object of the invention is to develop a two stroke Zindler curve eccentric ring gear internal combustion rotary engine.

Another object of the invention is to develop a two stroke Zindler curve eccentric ring gear internal combustion rotary engine with an equilateral triangular rotor of minimal eccentricity, consists of one or more planetary gear on either sides of a sun gear, so that the engine does not have any vibration.

Another object of the invention is to develop a two stroke Zindler curve eccentric ring gear internal combustion rotary engine which has high compression ratio so that diesel fuel can also be used.

Another object of the invention is to develop a two stroke Zindler curve eccentric ring gear internal combustion rotary engine which is more efficient than the reciprocating engine.

Another object of the invention is to develop a two stroke Zindler curve eccentric ring gear internal combustion rotary engine which uses effective cooling system.

Another object of the invention is to develop a two stroke Zindler curve eccentric ring gear internal combustion rotary engine which can be modified so that other fuels can also be used.

Another object of the invention is to develop a two stroke Zindler curve eccentric ring gear internal combustion rotary engine which does not have any valve mechanism.

Another object of the invention is to develop a two stroke Zindler curve eccentric ring gear internal combustion rotary engine which has higher thermal efficiency.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

A two stroke internal combustion rotary engine with Zindler curve eccentric ring gear and method of working of a two stroke internal combustion rotary engine with Zindler curve eccentric ring gear is disclosed. The engine has an equilateral triangular rotor with curved shaped eccentric ring gear with teeth cuts. An output shaft is fixed about to the center of the engine with a center spur gear and it also connected to same sized another two spur gear on the left or right sides of the center spur gear. When engine start working, the equilateral triangular rotor and eccentric ring gear will rotate eccentrically along with the left or right spur gears connected to it, by running over the teeth cuts. When center spur gear rotates it will rotate the left or right spur gears connected to it and these left or right spur gears will rotate the eccentric ring gears connected to it by running on the teeth cuts.

A two stroke internal combustion rotary engine with Zindler curve eccentric ring gear and method of working of a two stroke internal combustion rotary engine with Zindler curve eccentric ring gear is disclosed. The engine has an equilateral triangular rotor with Zindler curve eccentric ring gear with teeth cuts. An output shaft is fixed about to the center of the engine with a center spur gear and it also connected to same sized another one spur gear on the left or right sides of the center spur gear. When engine start working, the equilateral triangular rotor and Equilateral triangular eccentric ring gear will rotate eccentrically along with the left (or right) spur gear connected to it by running over the teeth cuts. When center spur gear rotates it will rotate the left or spur gear connected to it and these left spur gear will rotate the eccentric ring gears connected to it by running on the teeth cuts.

In a first aspect of the present disclosure, two stroke internal combustion rotary engine, the engine characterized in that: an equilateral triangle rotor comprising: at least one center spur gear; at least one side spur gear located on a side of the center spur gear; a rotor casing for housing the center spur gear and the side spur gear; and a ring gear formed on the inner surface of the rotor casing, wherein the center spur gear and the side spur gear eccentrically rotates by engaging with at least one teeth of the ring gear; an engine casing for housing the equilateral triangle rotor; a main shaft connected to the center spur gear; and a pair of engine covers for covering a top face and bottom face of the engine casing, wherein the engine covers comprises: at least one bearing slot at the center of the engine covers for allowing the shaft to pass through; at least one small bearings fitted on the engine covers to allow proper fitting of the side spur gear; and at least one groove housed with at least one steel ball fitted on the covers.

According to an embodiment in conjunction to the first aspect of the present disclosure, wherein the groove is a closed groove.

According to an embodiment in conjunction to the first aspect of the present disclosure, wherein the steel ball rolls over the closed groove when the equilateral triangle rotor rotates.

According to an embodiment in conjunction to the first aspect of the present disclosure, wherein the engine cover has an inlet hole through which at least one coolant passes through an inner surface of the equilateral triangle rotor and over the side spur gear and the center spur gear.

According to an embodiment in conjunction to the first aspect of the present disclosure, wherein the engine covers has an outlet hole through which the coolant after absorbing an excess heat produced by the engine during combustion process.

According to an embodiment in conjunction to the first aspect of the present disclosure, wherein the side spur gear of the equilateral triangle rotor when eccentrically rotates by engaging with at least one teeth of the ring gear, a rotation path is formed on an inner peripheral surface of the rotor casing.

According to an embodiment in conjunction to the first aspect of the present disclosure, wherein the rotation path in the rotor casing is used to form the geometric structure of the engine casing.

According to an embodiment in conjunction to the first aspect of the present disclosure, wherein a combustion chamber is formed between the equilateral triangle rotor and the rotor casing.

According to an embodiment in conjunction to the first aspect of the present disclosure, the equilateral triangle rotor rotates in opposite direction of that of the main shaft.

According to an embodiment in conjunction to the first aspect of the present disclosure, wherein the steel balls fall into the rotation path on the inner peripheral surface of the rotor casing, when the equilateral triangle rotor rotates.

According to an embodiment in conjunction to the first aspect of the present disclosure, wherein a required fixed speed of the main shaft is obtained by varying selecting a diameter of at least one of the center spur gear or the side spur gear.

According to an embodiment in conjunction to the first aspect of the present disclosure, wherein the engine cover has at least one hole to allow at least one coolant to enter the equilateral triangle rotor and absorb the excess heat during combustion process.

According to an embodiment in conjunction to the first aspect of the present disclosure, wherein the engine covers has at least one hole to remove the excess heat produced after combustion process.

According to an embodiment in conjunction to the first aspect of the present disclosure, wherein the coolant passes from the hole of the engine cover enters into the equilateral triangular rotor flows over the side spur gears and the center spur gear.

According to an embodiment in conjunction to the first aspect of the present disclosure, wherein rotation of the equilateral triangular rotor generates at least three power strokes in one revolution.

According to an embodiment in conjunction to the first aspect of the present disclosure, wherein the three power stroke includes three suctions, three compressions and three exhausts.

In a second aspect of the present disclosure, a method of working of the two stroke internal combustion rotary engine, the thermodynamic method are performed to rotate the equilateral triangular rotor inside the engine casing, the method characterized with the following steps: opening the inlet port to inject fuel into a compression or combustion chamber, at angle 170 degree; closing the inlet port when the rotor rotates to about angle 160 degree; forming spark from the spark plug at angle between 70 to 60 degree spark; igniting the compressed air and fuel mixture in the compression chamber; beginning expansion of ignited air and fuel mixture from angle 60 degree; undergoing expansion process in engine and finally complete the expansion at angle 220 degree; opening the exhaust port when the rotor rotates at angle 220 degree; starting the exhaustion process and finally exhaust port closes at angle 210 degree; starting vacuum process from angle 210 degree; sucking fresh air from outside and completes a first thermodynamic cycle at angle 170 degree; and preparing the engine for the subsequent thermodynamic cycle.

According to an embodiment in conjunction to the second aspect of the present disclosure, wherein the first thermodynamic cycle preforms the steps of: rotating the equilateral triangular rotor inside the engine casing; rotating the side spur gear when the ring gear in the equilateral triangular rotor rotates; rotating the center spur gear when the side spur gear rotates; and rotating the main shaft when the center spur gear rotates.

### BRIEF DESCRIPTION OF THE DRAWINGS

FIG. 1 is an illustration of a two stroke internal combustion rotary engine 30 with Zindler curve eccentric ring gear 8 and rotor 7, in accordance with the disclosed embodiment of the invention.

FIG. 2 is an illustration of engine covers 16 and 17 of the two stroke internal combustion rotary engine 30, in accordance with the disclosed embodiment of the invention.

FIG. 3 is an illustration of an engine casing 1 of the two stroke internal combustion rotary engine 30, in accordance with the disclosed embodiment of the invention.

FIG. 4A, FIG. 4B and FIG. 4C is an illustration of a rotor 7 of the two stroke internal combustion rotary engine 30, in accordance with the disclosed embodiment of the invention.

FIG. 5 is an illustration of a gear and shaft arrangement 34 of the two stroke internal combustion rotary engine 30, in accordance with the disclosed embodiment of the invention.

FIG. 6 is an illustration of a graph 70 showing the operation of various elements during the combustion processes of the two stroke internal combustion rotary engine 30, in accordance with the disclosed embodiment of the invention.

FIG. 7 is an illustration of a two stroke internal combustion rotary engine 30 with Zindler curve eccentric ring gear 8 and rotor 7, in accordance with the alternative embodiment of the invention.

FIG. 8 is an illustration of a rotor 7 of the two stroke internal combustion rotary engine 30 without spear gears, in accordance with the alternative embodiment of the invention.

FIG. 9 is an illustration of a flow chart pertaining to an example method 80 of operating the two stroke internal combustion rotary engine with Zindler curve eccentric ring gear, in accordance with the disclosed embodiment of the invention.

FIG. 10 is an illustration of a flow chart pertaining to an example method 95 of operating the two stroke internal combustion rotary engine with Zindler curve eccentric ring gear, in accordance with the disclosed embodiment of the invention.

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

### DETAILED DESCRIPTION OF ILLUSTRATIVE EMBODIMENTS

The particular configurations discussed in the following description are non-limiting examples that can be varied and are cited merely to illustrate at least one embodiment and are not intended to limit the scope thereof.

The present disclosure relates generally to a rotary engine. Embodiments of the disclosure are related to a two stroke internal combustion rotary engine with Zindler curve eccentric ring gear. Embodiments of the disclosure are also related to method of working of a two stroke internal combustion rotary engine with Zindler curve eccentric ring gear.

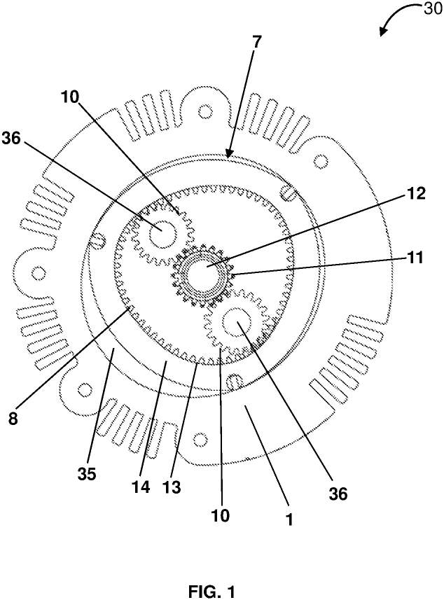

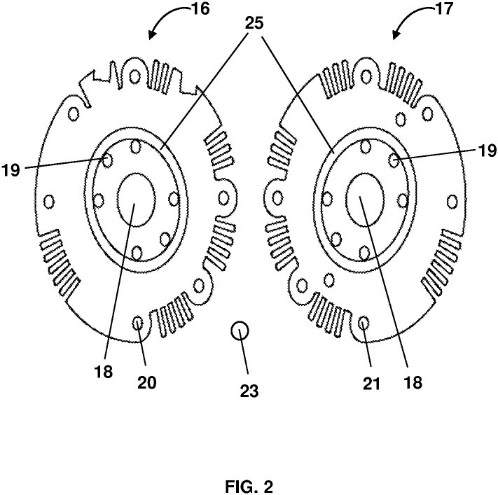

FIG. 1 is an illustration of a two stroke internal combustion rotary engine 30 with a Zindler curve eccentric ring gear 8, in accordance with the disclosed embodiment of the invention. The two stroke internal combustion rotary engine 30 has an equilateral triangle rotor 7, an engine casing 1 and a pair of covers (shown in FIG. 2). The equilateral triangle rotor 7 comprises at least one center spur gear 11, at least one pair of side spur gears 10, a rotor casing 14 and the ring gear 8.

The pair of side spur gears 10 are located on either side of the center spur gear 11. The rotor casing 14 houses the center spur gear 11 and the pair of side spur gears 10. The ring gear 8 is formed on the inner surface 13 of the rotor casing 14. The center spur gear 11 and the side spur gears 10 eccentrically rotates by engaging with at least one teeth of the ring gear 8. The center spur gear 11 of the rotor 7 is connected to the shaft 12, which is used to transmit the rotational energy of the rotor 7 to the devices, for example, related to aviation engineering and automobiles. The engine casing 1 houses the equilateral triangle rotor 7. A combustion chamber 35 is formed in the space between the equilateral triangle rotor 7 and the engine casing 1. In the combustion chamber 35, after fuel is injected into it, the combustion of the fuel-air mixture takes place to start the thermodynamic process of the present invention.

It should be noted that the ring gear 8 or the rotor 7 is of a Zindler curve shape. The Zindler curve is a simple closed plane curve with the defining property. All chords, which cut the curve length into halves, have the same length. One example of such Zindler curve of ring gear 8 is shown in FIG. 1. The inner peripheral surface 13 of the rotor casing 14 has the Zindler curve eccentric ring gear 8 with teeth cuts.

In FIG. 1, the engine covers are not shown. Other essential elements that are present at the back of the cover are shown to explain the overall working of the present invention. The essential elements include rotor 7, rotor casing 14, center spur gear 11, left and right spur gears 10 are shown along with the engine covers 16, to illustrate the working of the engine 30. The left and right shafts 36 from the left and right spur gears 10 are fitted in proper manner into the small bearings of the engine covers to ensure smooth working of the engine 30.

FIG. 2 is an illustration of a pair of engine covers 16 and 17 of the two stroke internal combustion rotary engine 30, in accordance with the disclosed embodiment of the invention. The pair of engine covers 16, 17 are used for covering a top face and bottom face of the engine casing 1. At least one bearing slot 18 is provided at the center of the engine covers 16, 17 for allowing the shaft 12 of the center spur gear 11 to pass through. At least one small bearing 19 is fitted on the engine covers 16, 17 to allow proper fitting of the side spur gears 10. In one embodiment of the invention, the engine cover 17 has at least one hole 20 to allow at least one coolant to enter the equilateral triangle rotor 7 and absorb the excess heat during combustion process. The engine covers 16 has at least one hole 21 to remove the excess heat produced after combustion process. The coolant passes from the hole 20 of the engine cover 17 and enters into the equilateral triangular rotor 7 and then flows over the side spur gears 10 and the center spur gear 11. The coolant absorbed the excess heat produced by the engine 30 at the time of combustion process and leave out through the hole 21 or outlet hole 21 on the bottom cover or engine cover 16. The coolant can be water or air, without limitation. In one embodiment of the invention, at least one groove 25 is housed with at least one steel ball 23 fitted on the covers 16, 17. In one another embodiment of the invention, the steel balls 23 can be fitted in rotor 7.

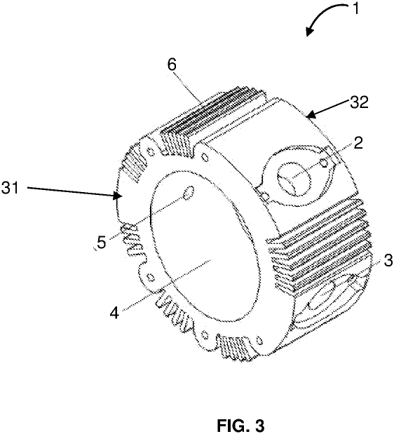

FIG. 3 is an illustration of an engine casing 1 of the two stroke internal combustion rotary engine 30, in accordance with the disclosed embodiment of the invention. The pair of engine covers 16, 17 of FIG. 2 can be used for covering a top face 31 and bottom face 32 of the engine casing 1.The engine casing has an inlet port 2, an outlet port 3, external fins 6 and a spark plug 5. The inlet port 2 is opened during the initial stage of the combustion process, through which the fuel is injected into the combustion chamber. The spark plug 5 is used to ignite the compressed air and fuel moisture in the compression chamber. Ignition creates high pressure in the chamber which lead to expansion of the rotor. The expansion process rotates the rotor further in anti-clockwise direction. After combustion, the exhaust from the combustion chamber is sent out of the engine through the outlet port 3 (also referred exhaust port 3). A rotation path is formed in the inner surface 4 of the engine casing 1 when the rotor inside the casing during the combustion process.

The outer casing 1 is made-up of a top face 31 and bottom face 32, which are covered or closed using the pair of engine covers 16, 17 of FIG. 2. The inlet port 2 and the outlet port 3 are positioned on the circumference of the engine casing 1, such that the rotation of the rotor inside the rotor casing, opens or closes the inlet port 2 and the outlet port 3 at the required predetermined angle of rotation of the rotor. For example, the inlet port 2 is opened only during the fuel injection stage. The outlet port is opened only during the exhaust stage. It should be noted that the disclosed invention does not have any valve mechanism, the opening and closing of the inlet port 2, the outlet port 3 and spark ignition takes place with the help of the geometric structure of the engine casing 1, structure of the rotor and the engine covers 16, 17 of FIG. 2.

If a path of a point on the corner of the equilateral triangular rotor is traced, it will give a geometrical structure corresponding to its path of rotation in the surface in which it rotates. This geometrical structure will give the dimension for the construction of outer casing of the engine. The outer casing is made-up of two side surfaces, one is on the upper side and another on the lower side of the engine and the disclosed invention does not have any valve mechanism. The engine rotor will keep rotating until this cyclic process of suction, compression, expansion, and exhaustion continuing. One example of the path traced is a Zindler curve.

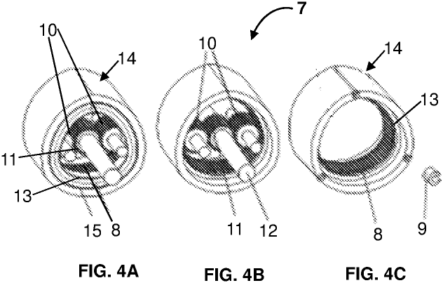

FIG. 4A, FIG. 4B and FIG. 4C is an illustration of a rotor 7 of the two stroke internal combustion rotary engine 30 of FIG. 1, in accordance with the disclosed embodiment of the invention. Referring to FIG. 4A, the equilateral triangle rotor 7 comprises the center spur gear 11, the pair of side spur gears 10 the rotor casing 14 and the ring gear 8. The inner peripheral surface 13 of the rotor casing 14 has the Zindler curve eccentric ring gear 8 with teeth cuts. When engine start, the eccentric ring gear 8 will rotate eccentrically along with the left or right spur gears 10 connected to it, by running over the teeth cuts of the gear 8. In FIG. 4A, the rotation path 15 is formed on the inner peripheral surface 13 of the rotor casing 14, when the pair of side spur gears 10 engages with the teeth of the ring gear 8.

FIG. 4B, clearly shows the pair of side spur gears 10.that is the left or the right side spur gears 10 positioned on either side of the center spur gear 11. Referring to FIG. 4C, a corner sailings 9 is positioned on all three corners and face sealing on the top and bottom sides of the equilateral triangular rotor casing 14. The corner sailings 9 is provided to prevent any kind of gas leakage from the combustion chambers during the combustion process.

When the engine 30 starts working, the equilateral triangular rotor 7 and eccentric ring gear 8 will rotate eccentrically along with the left or right spur gears 10 connected to it, by running over the teeth cuts. When combustion process starts, the rotor 7 rotates which will rotate the eccentric ring gears. The teeth of eccentric ring gears are engaged with the teeth of the left and/or right spur gears 10. Rotation of the eccentric ring gears rotates the left and/or right spur gears 10 which in turn rotates the center spur gear 11, thus rotating the shaft 12.

Referring to FIGS. 1-3, the rotor casing 14 is used to maintain the concentric rotation of the equilateral triangular rotor 7. The said rotor casing 14 has a path 15 on its inner surface 13. The engine covers 16 and 17 provided on top and bottom faces of the engine casing 1has two grooves 22 and steel balls 23 in it on directly opposite sides. When the top and bottom sides/faces of the engine casing 1 are covered by the engine covers 16 and 17, the said steel balls 23 in the grooves 22 falls into the path 15, as shown in FIG. 4A, on the faces of equilateral triangular rotor 7 and when the rotor 7 start working it rolls over the steel balls 23 which are fixed stationary in the grooves 22. The biggest advantage of the grooves mechanism is that it produces the radial load only on the faces of the equilateral triangular rotor 7, because of its peculiar design and arrangement between the engine casing 1 and engine covers 16, 17 and thereby whenever the equilateral triangular rotor 7 rotates it always maintains the concentric rotation.

The rotor 7 is always rotating in opposite direction of that of the main shaft 12 that is whenever the main shaft 12 rotates in clock wise direction, the equilateral triangular rotor 7 will rotate in anti-clock wise direction.

It should be noted that the radius of curve of equilateral triangular rotor 7 is approximately equal and always less than that of radius of curve of outer engine casing 1, so that the equilateral triangular rotor 7 can freely rotates within the peripheral of engine casing 1 without any distractions.

The present invention uses a rotor cooling mechanism working either by water or air. The rotor cooling mechanism maintain the optimum temperature, for example, 80 degree C, of the equilateral triangular rotor 7, so that the engine 30 can carry out the proper thermodynamic process. The hole 20 or inlet hole 20 provided in the top face cover 17, as shown in FIG. 2, allows the coolant to pass through and further enters into the equilateral triangular rotor 7and flows over the inner peripheral surface 13 of the rotor casing 14. Since the spur gears 10are in rotation, the coolant substance which enter into the interior of the equilateral triangular rotor 7 also circulates along the spur gears 10. Finally, the water or air which absorbed the excess heat produced by the engine 30 leave out through the outlet hole 21 on the bottom engine cover 16 to the radiator and then to the water tank (not shown) to continue this cyclic process. The advantage of this said rotor cooling mechanism is that it can cool down and sustain the temperature of the whole interior of the equilateral triangular rotor such that center ring gear 11, left and right spur gear 10 and main shaft 12 at 80 degree C.

Referring again to FIG. 4A, that is speed of the engine 30 can be either increased or decreased, but once it is fixed then it cannot be altered. Depending upon the requirement of each applications, the speed of the engine 30 can be fixed well in advance. By varying the diameter of linearly arranged spur gears 10, 11, the speed of the engine can be varied. The total sum of diameter of linearly arranged spur gears 10, 11 is always constant so that when the diameter of center spur gear 11 increases there will be a proportional decrease in the diameter of left or right spur gears 10 and if the diameter of center spur gear 11 increase it will result proportional decrease in the diameter of other gears 10. When the diameter of center spur gear 11 increases there will be a corresponding increase in the number of teeth cuts and thereby decrease in the time taken for one complete revaluation and decreased output drive speed and vice versa.

Most commonly using engine does not have this speed controlling mechanism due to the lack of gear driven mechanism in all these engines. But this longstanding defect is rectified by the peculiar design of present invention engine 30 in which the power can be drawn only from the linearly arranged spur gears 10, 11 such as center spur gear, left, and right spur gear. The rotation path 15 is formed on the inner peripheral surface of the rotor casing 14 is shown clearly in FIG. 4A.

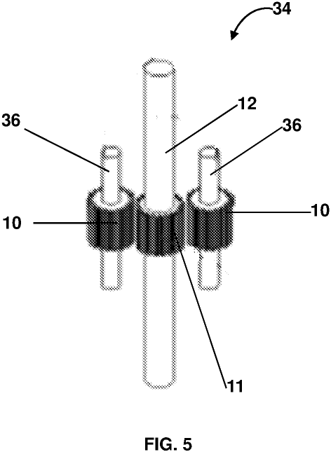

FIG. 5 is an illustration of a gear and shaft arrangement 34 of the two stroke internal combustion rotary engine 30, in accordance with the disclosed embodiment of the invention. An output shaft 12 is fixed about a center of the engine with the center spur gear 11. In one embodiment of the invention, the size of the two spur gear 10 on the left or right sides and that of the center spur gear 11 are same and the teeth in the left or right gear 10 are engaged with the teeth of the center gear 11. The main shaft or center shaft 12 passes through the bearing slot 18 at the center of the engine covers 16, 17, as shown in FIG. 2. The left or right shafts 36 from the left and right spur gears 10 are fitted in proper manner into the small bearings 19 of the engine covers 16, 17, to ensure smooth working of the engine 30.

A rotation path 15 in inner peripheral surface 13 of the rotor casing 14 is traced using at least one corner point of the equilateral triangular rotor 7, by rotating the rotor 7. The rotation path 15 is used to get a geometrical structure and dimension for the construction of engine casing 1of the engine 30.

The center of inner periphery surface 13 of the equilateral triangular rotor 7 has teeth cuts known as ring gear 8. The ring gear 8 is always in an eccentric rotation hence also referred as eccentric ring gear 8. A set of linearly arranged spur gears such as center spur gears 11, the left or right spur gears 10 are connected to each other as shown in FIG. 5 such that the left or right spur gears 10 rotates over the said ring gear 8 and facilitates power transmission.

It should be noted that the engine casing 1 is covered using the engine covers 16, 17 by tightly securing to the engine covers 16, 17 to the engine case using at least one securing means. The main shaft 12 connected to the center spur gear 11 leaves outside through the main bearing slots 18 at the center of the engine covers 16, 17. Similarly, the side inner shaft 36 connected to the left or right spur gears 10 leaves outside through the main small bearing slots on either side of the center of the engine covers 16, 17. Any suitable bearing seat can be used to fix all these bearing slots.

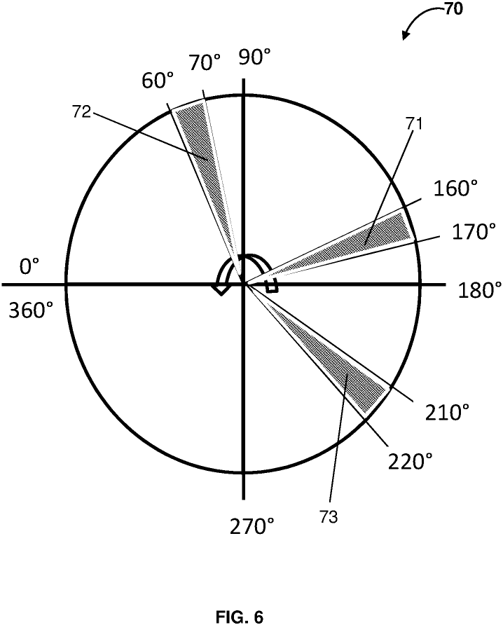

FIG. 6 is an illustration of a graph showing the operation of various elements during the combustion processes of the two stroke internal combustion rotary engine 30, in accordance with the disclosed embodiment of the invention. The rotor commence the rotation from 170 degree and rotates in anti-clock wise direction. The Table 1 shown below explains each thermodynamic cyclic process and corresponding degree of rotation of the engine.

TABLE 1

| | |
|---|---|
| DEGREE OF ROTATION | CORESSPONDING DEGREE OF ROTATION |
| 170 degree to 160 degree | At 170 degree the inlet port get opens and the fuel injects into it, finally the inlet port closes when the rotor rotates to 160 degree. |
| 160 degree to 70 degree | From 160 degree compression process starts, that is mixed air and injected fuel undergoes compression and completes at 70 degree. |
| 70 degree to 60 degree | In between 70 to 60 degree a spark forms from the spark plug and it ignites the compressed air-fuel mixture in the compression chamber. |
| 60 degree to 220 degree | From 60 degree, ignited air-fuel mixture begins expands and the engine undergoes expansion process, finally completes at 220 degree. |
| 220 degree to 210 degree | When the rotor rotates 220 degree, the exhaust port get opens and starts the exhaustion process and finally it closes at 210 degree. |
| 210 degree to 170 degree | From 210 degree vacuum process starts and sucks fresh air from outside and completes the first cycle at 170 degree and prepared |

As shown in graph 70, the inlet port is opened between the angles 170 degree to 160 degree of the rotor, as indicated by the reference numeral 71. The spark plug ignites the compressed air and fuel mixture in the compression chamber between the angles 70 degree to 60 degree of rotation of the rotor, as indicated by the reference numeral 72. When the rotor rotates 220 degree, the exhaust port opens and starts the exhaustion process and finally it closes at 210 degree, as indicated by the reference numeral 73.

It should be noted that for all existing engines to start their working, it requires an initial drive and usually which is provided by any kind of external agents for example, a self-starter. The disclose invention also uses such self-starter, and it is connected to a flywheel. As the self-starter rotates, the flywheel also rotates, on its initial drive the equilateral triangular rotor 7 will begins to rotate and at 170 degrees, the inlet port 2 will become open and air get sucked in to the suction chamber. This initiates the thermodynamic process.

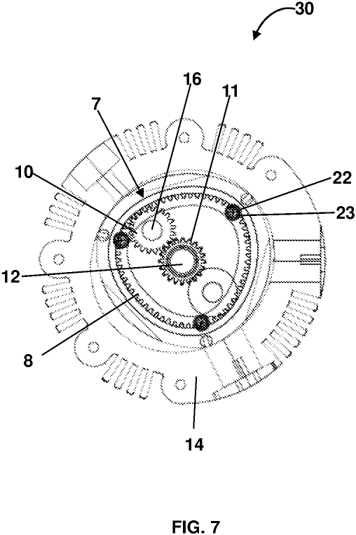

FIG. 7 is an illustration of a two stroke internal combustion rotary engine 30 with equilateral triangle eccentric ring gear 8 and rotor 7, in accordance with the alternative embodiment of the invention. The engine 30 has the equilateral triangular rotor 7 with Zindler curve eccentric ring gear 8 with teeth cuts. An output shaft 12 is fixed about to the center of the engine 30 with a center spur gear 11 and it also connected to same sized another spur gear 10 on the left or right sides of the center spur gear 11. When engine start working, the equilateral triangular rotor 7 and eccentric ring gear 8 will rotate eccentrically along with the left (or right) spur gear 10 connected to it, by running over the teeth cuts. When center spur gear 11 rotates it will rotate the left spur gear 10 connected to it and the left spur gear 10 will rotate the eccentric ring gears 8 connected to it by running on the teeth cuts. In one embodiment of the invention, the side spur gear 10 is positioned at a side of the center spur gear 11. In another embodiment of the invention, the side spur gear 10 is positioned at a place around the center spur gear 11. In one another embodiment of the invention, at least one supporting structure can be placed around the center spur gear 11 opposite to the side spur gear 10 as a counter structure to allow smooth operation the center spur gear 11 and the side spur gear 10.

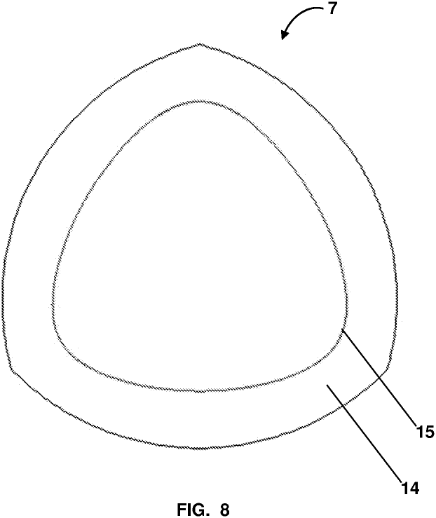

The equilateral triangular rotor 7 has three steel balls 23 fixed each on three groove 22 at an apex of the rotor casing 14, as shown in FIG. 7. Referring to the FIG. 2 the engine covers 16 and 17 are provided with a closed oval like groove 25. When the top and bottom sides of the engine casing 1 are covered by the engine covers 16 and 17, the steel balls 23 falls into the groove 25 on the engine covers 16 and 17 and forms the path 15, as shown in FIG. 8. When the rotor 7 starts, the steel balls 23 which are fixed in rotor 7 rolls through the groove 25. The biggest advantage of this ball-groove mechanism is that, it produces the radial load only on the faces of the equilateral triangular rotor 7. This peculiar design and arrangement between the engine casing 1 and engine covers 16, 17 always maintain the concentric rotation whenever the equilateral triangular rotor 7 rotates it. FIG. 8 is the rotor 7 shown without center and side spear gears. The path 15 is formed on the rotor 7 by the balls 23 when the rotor 7 starts rotating.

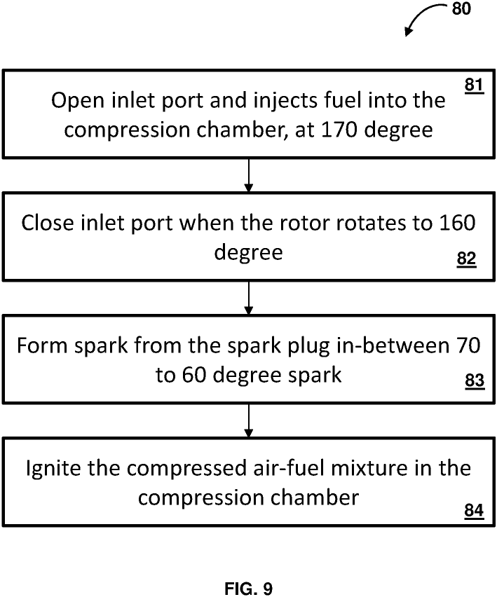

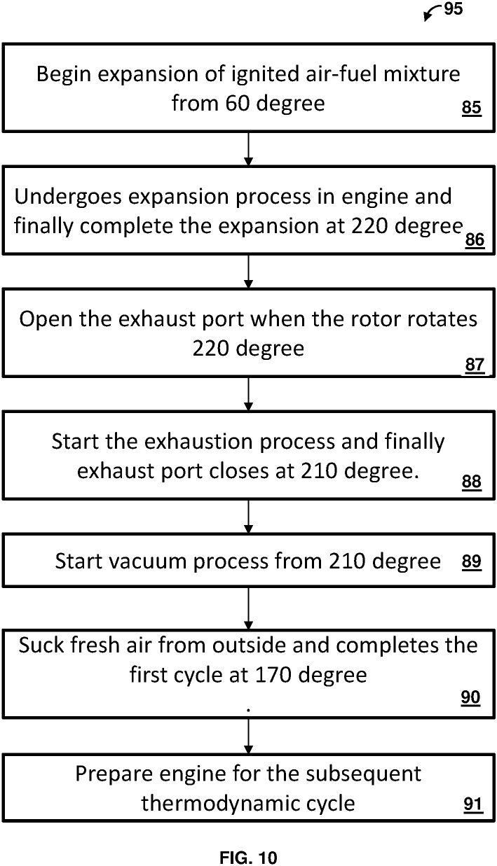

FIG. 9 and FIG. 10 are illustration of flow charts pertaining to an example thermodynamic methods 80 and 95 of operating the two stroke internal combustion rotary engine with Zindler curve eccentric ring gear, in accordance with the disclosed embodiment of the invention. The steps in methods 80 and 95 are performed when the rotor of the engine is rotated in anticlockwise direction. Referring to FIG. 9, as at step 81, the inlet port is opened to inject fuel into a compression chamber, at angle 170 degree. Then, as at step 82, the inlet port closed when the rotor rotates to 160 degree. Then, as at step 83, a spark is formed from a spark plug at angle between 70 to 60 degree spark. Then, the compressed air and fuel mixture is ignited in the compression chamber, as at step 84.

FIG. 10 is an illustration of a flow chart pertaining to an example thermodynamic method 95 of operating the two stroke internal combustion rotary engine with Zindler curve eccentric ring gear, in accordance with the disclosed embodiment of the invention. After the ignition, as at step 85 of FIG. 10, expansion of ignited air and fuel mixture begins from angle 60 degree of the rotor. As at step 86, the engine undergoes expansion process and finally the expansion process is completed at angle 220 degree. As at step 87, the exhaust port opens when the rotor rotates at angle 220 degree. The exhaustion process starts and finally exhaust port closes at angle 210 degree, as at step 88. Then the vacuum process starts from angle 210 degree, as at step 89. The fresh air is sucked from outside and sucking process completes the first cycle at angle 170 degree, as at step 90. Finally as at step 91, the engine prepares for the next thermodynamic process.

It should be noted that the method includes the three power stroke including three suctions, three compressions and three exhausts. The thermodynamic cycle rotates the equilateral triangular rotor inside the engine casing. The ring gear in the equilateral triangular rotor starts rotating and in tum rotates the side spur gear. The side spur gear rotates the center spur gear engage with it, which in tum rotates the main shaft.

The internal combustion rotary engine of present invention comprises the Zindler curve eccentric ring gear with an equilateral triangular rotor of minimal eccentricity. The rotor consists of at least one planetary ring gear on the sides of a main sun gear, so that the engine does not have any vibration. The rotary engine of present invention has high compression ratio so that diesel and other fuels can also be used. Further, the rotary engine uses effective cooling system and is more efficient than the reciprocating engine. Another main advantage of the present invention is that the two stroke Zindler curve eccentric ring gear internal combustion rotary engine which does not have any valve mechanism and has higher thermal efficiency.

It will be appreciated that variations of the above disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

Although embodiments of the current disclosure have been described comprehensively in considerable detail to cover the possible aspects, those skilled in the art would recognize that other versions of the disclosure are also possible.

I claim:

1. A two stroke internal combustion rotary engine (30), the engine (30) characterized in that:
an equilateral triangle rotor (7) comprising:
at least one center spur gear (11);
at least one side spur gear (10) located on a side of the center spur gear (11);
a rotor casing (14) for housing the center spur gear (11) and the side spur gear (10): and
a Zindler curve ring gear (8) formed on the inner surface (13) of the rotor casing (14), wherein the center spur gear (11) and the side spur gear (10) eccentrically rotates by engaging with at least one teeth of the Zindler curve ring gear (8);
an engine casing (1) for housing the equilateral triangle rotor (7);
a main shaft (12) connected to the center spur gear (11); and
a pair of engine covers (16, 17) for covering a top face (31) and bottom face (32) of the engine casing (1), wherein the engine covers (16, 17) comprises:
at least one bearing slot (18) at the center of the engine covers (16, 17) for allowing the shaft (12) to pass through;
at least one small bearings (19) fitted on the engine covers (16, 17) to allow proper fitting of the side spur gear (10); and
at least one groove (25) housed with at least one steel ball (23) fitted on the covers (16, 17).

2. The engine (30) of claim 1, wherein the groove is a closed groove (25).

3. The engine (30) of claim 2, wherein the steel ball (23) rolls over the closed groove (25) when the equilateral triangle rotor (7) rotates.

4. The engine (30) of claim 1, wherein the engine cover (16) has an inlet hole (20) through which at least one coolant passes through an inner surface (13) of the equilateral triangle rotor (7) and over the side spur gear (10) and the center spur gear (11).

5. The engine (30) of claim 1, wherein the engine covers (16, 17) has an outlet hole (21) through which the coolant after absorbing an excess heat produced by the engine during combustion process.

6. The engine (30) of claim 1, wherein the side spur gear (10) of the equilateral triangle rotor (7) when eccentrically rotates by engaging with at least one teeth of the Zindler curve ring gear (8), a rotation path (15) is formed on an inner peripheral surface (13) of the rotor casing (14).

7. The engine (30) of claim 6, wherein the rotation path (15) in the rotor casing (14) is used to form the geometric structure of the engine casing (1).

8. The engine (30) of claim 1, wherein a combustion chamber (35) is formed between the equilateral triangle rotor (7) and the rotor casing (14).

9. The engine (30) of claim 1, wherein the equilateral triangle rotor (7) rotates in opposite direction of that of the main shaft (12).

10. The engine (30) of claim 1, wherein the steel balls (23) fall into the rotation path (15) on the inner peripheral surface (13) of the rotor casing (14), when the equilateral triangle rotor (7) rotates.

11. The engine (30) of claim 1, wherein a required fixed speed of the main shaft (12) is obtained by varying selecting a diameter of at least one of the center spur gear (11) or the side spur gear (10).

12. The engine (30) of claim 1, wherein the engine cover (17) has at least one hole (20) to allow at least one coolant to enter the equilateral triangle rotor (7) and absorb the excess heat during combustion process.

13. The engine (30) of claim 12, wherein the engine covers (16) has at least one hole (21) to remove the excess heat produced after combustion process.

14. The engine (30) of claim 13, wherein the coolant passes from the hole (20) of the engine cover (17) enters into the equilateral triangular rotor (7) flows over the side spur gears (10) and the center spur gear (11).

15. The engine (30) of claim 1, wherein rotation of the equilateral triangular rotor (7) generates at least three power strokes in one revolution.

16. The engine (30) of claim 15, wherein the three power stroke includes three suctions, three compressions and three exhausts.

17. The engine (30) of claim 1, wherein the engine casing (1) has an inlet port (2) through which the fuel injected into the combustion chamber (35) and an exhaust port (3) to exhale the exhaust gas from the combustion chamber (35).

18. A method of working of the two stroke internal combustion rotary engine (30) of claim 1, the thermodynamic method (80, 95) are performed to rotate the equilateral triangular rotor (7) inside the engine casing (1), the method (80, 95) characterized with the following steps:
opening the inlet port (2) to inject fuel into the combustion chamber (35), at angle 170 degree;
closing the inlet port (2) when the rotor (7) rotates to about angle 160 degree;
forming spark from the spark plug at angle between 70 to 60 degree spark;
igniting the compressed air and fuel mixture in the combustion chamber (35);
beginning expansion of ignited air and fuel mixture from angle 60 degree
undergoing expansion process in engine and finally complete the expansion at angle 220 degree
opening the exhaust port (3) when the rotor rotates at angle 220 degree
starting the exhaustion process and finally exhaust port (3) closes at angle 210 degree;
starting vacuum process from angle 210 degree;
sucking fresh air from outside and completes a first thermodynamic cycle at angle 170 degree; and
preparing the engine for the subsequent thermodynamic cycle.

19. The method of claim 18, wherein the first thermodynamic cycle preforms the steps of:
rotating the equilateral triangular rotor (7) inside the engine casing (1);
rotating the side spur gear (10) when the Zindler curve ring gear (8) in the equilateral triangular rotor (7) rotates;
rotating the center spur gear (11) when the side spur gear (10) rotates; and
rotating the main shaft (12) when the center spur gear (11) rotates.
